(19) United States
(12) Patent Application Publication
(10) Pub. No.: US 2014/0039946 A1
(43) Pub. Date: Feb. 6, 2014

(54) Reservation system and apparatus for reserving occupancy of a communal item and method of use

(71) Applicants: Erin Coleen Spiker, Dublin, OH (US); Jeffery Allen Spiker, Dublin, OH (US); Molly Kay Ritchey, Zanesville, OH (US); John Wesley Beal, Delaware, OH (US); Shawn Steven Flannery, Galena, OH (US)

(72) Inventors: Erin Coleen Spiker, Dublin, OH (US); Jeffery Allen Spiker, Dublin, OH (US); Molly Kay Ritchey, Zanesville, OH (US); John Wesley Beal, Delaware, OH (US); Shawn Steven Flannery, Galena, OH (US)

(21) Appl. No.: 14/027,311

(22) Filed: Sep. 16, 2013

Related U.S. Application Data
(63) Continuation-in-part of application No. 13/066,409, filed on Apr. 14, 2011, now Pat. No. 8,565,044.
(60) Provisional application No. 61/344,068, filed on May 17, 2010.

(51) Int. Cl. G06Q 10/02

(52) U.S. Cl. CPC G06Q 10/02
USPC 705/5

(57) ABSTRACT

A reservation system, apparatus, and method allows a user to reserve occupancy of a communal item. To do so, a reservation device which is connectable to the communal item includes an available state in which the communal item is available for use, and a reserved state in which the communal item is reserved. The reservation device includes a motion sensor which senses when the communal item is occupied. If the user vacates the communal item for a time interval, a timer starts counting off a time period. If the user does not reoccupy the communal item before the time period elapses, the reservation device changes from the reserved state to the available state. The reservation device also allows the user to make service requests.

### CROSS REFERENCE TO RELATED APPLICATION

This application is a Continuation-In-Part of and claims the filing benefit under 35 U.S.C. §120 of application Ser. No. 13/066,409, filed Apr. 14, 2011, and also claims the filing benefit under 35 U.S.C. §119(e) of U.S. Provisional Application No. 61/344,068, filed May 17, 2010, both of which previously filed applications are hereby incorporated by reference.

### TECHNICAL FIELD

The present invention pertains generally to communal items, and more particularly to a reservation system for reserving occupancy of a communal item.

### BACKGROUND OF THE INVENTION

In certain venues communal items are made available for the use of multiple users. For example lounge chairs are typically provided for the guests of cruise ships and hotel swimming pool areas. The lounge chairs are occupied on a first-come-first-serve basis, and remain occupied until the current user elects to leave the area. If however there are an insufficient number of lounge chairs to accommodate all guests, then some guests must wait for a lounge chair to become available. The wait can be frustrating since there is usually no provision for sharing the communal item by limiting the period of use. Also, confusion can arise as to whether the communal item is in fact in use. That is, if the communal item is physically unoccupied but some personal articles are disposed in the area, it can be unclear to a desirous user if the communal item is now available.

In view of the above, it would be useful to provide a means by which the time of occupancy of a communal item can be regulated, and further which provides a positive indication as to the availability of the communal item.

### BRIEF SUMMARY OF THE INVENTION

The present invention is directed to a reservation system, apparatus, and method for reserving occupancy of a communal item. The reservation system allows both operational personnel and guests to easily identify lounge chairs or other communal items which are available vs. reserved resulting in a more equitable and efficient use of facility resources. The system and apparatus also enable facility personnel to identify and locate guests who desire service(s) such as food and beverage. It also allows the facility to advertise current promotions to guests while they are lounging in the communal item. Some of the features of the system are:
The system includes a reservation device which is easily connected to (and removable from) the communal item.
The reservation device has user friendly controls and displays.
The reservation device wirelessly communicates with a computer-controlled base station via repeaters.
The reservation device includes a timing mechanism which indicates the amount of time a communal has been unoccupied.
The reservation device includes a service request feature so that guests can remotely request service.
The reservation system allows the facility to send promotional advertisements or other messages to guests while they are occupying the communal item.
The base station monitors communal item utilization and service requests.
The system employs a mesh wireless network which permits a specific communal item to be approximately located.

Some of the advantages of the reservation system are;
Improves guest relations since all guests have equal opportunity to utilize a communal item by eliminating “hogging”.
Frees up additional square feet of “real estate” for other purposes because fewer communal items are required
Saves the facility money on new or additional communal items because the existing items are used more efficiently
Increases revenue from beverages and food sales because of the ability to communicate the need for “service”
Enables a more efficient use of operational personnel by reducing the need to manually monitor communal items.
Provides the ability to track the utilization of communal items and service requests including but not limited to the time required for fulfillment of service requests

In accordance with an embodiment, a reservation system for reserving occupancy of a communal item includes a communal item placement area. A communal item is disposed in the communal item placement area. The reservation system further includes a reservation device which is connectable to the communal item. The reservation device includes an available state in which the communal item is available for use, a reserved state in which the communal item is reserved by a user, a timer which runs for a period of time, and a timer activator which starts the timer.

In accordance with another embodiment, the reservation system includes a base station. The reservation device is capable of wirelessly communicating with the base station.

In accordance with another embodiment, the communal item placement area is divided into a plurality of zones, and the communal item resides in one of the plurality of zones. In accordance with another embodiment, each of the plurality of zones has a repeater.

Communication between the reservation device and the base station is via the repeater which is located in the same zone as the communal item.

In accordance with another embodiment, a plurality of communal items are disposed in the communal item placement area. The reservation system includes a mesh wireless network wherein each of the repeaters communicates with (1) the base station, (2) other the repeaters, and (3) multiple reservation devices.

In accordance with another embodiment, the reservation device has a communal item identifier, and the reservation device is capable of sending the base station a communal item reserved signal which includes the communal item identifier.

In accordance with another embodiment, the communal item placement area is divided into a plurality of zones, and the communal item resides in one of the plurality of zones. Each of the plurality of zones has a repeater, each repeater having a zone identifier. Communication between the reservation device and the base station is via the repeater which is located in the same zone as the communal item. The repeater receives the communal item reserved signal from the reservation device and passes the communal item reserved signal to the base station. The repeater measures the signal strength of the communal item reserved signal received from the reservation device, and adds the signal strength to the communal item reserved signal before it is passed to the base station. The repeater also adds the zone identifier of the repeater to the communal item reserved signal before it is passed to the base station.

In accordance with another embodiment, the reservation device has a communal item identifier, and the reservation device is capable of sending the base station a communal item available signal which includes the communal item identifier.

In accordance with another embodiment, the communal item placement area is divided into a plurality of zones, and the communal item resides in one of the plurality of zones. Each of the plurality of zones has a repeater, each repeater having a zone identifier. Communication between the reservation device and the base station is via the repeater which is located in the same zone as the communal item. The repeater receives the communal item available signal from the reservation device and passes the communal item available signal to the base station. The repeater measures the signal strength of the communal item available signal received from the reservation device, and adds the signal strength to the communal item available signal before it is passed to the base station. The repeater also adds the zone identifier of the repeater to the communal item available signal before it is passed to the base station.

In accordance with another embodiment, the reservation device has a communal item identifier, and the reservation device is capable of sending the base station a service request signal which includes the communal item identifier.

In accordance with another embodiment, the communal item placement area is divided into a plurality of zones, and the communal item resides in one of the plurality of zones. Each of the plurality of zones has a repeater, each repeater having a zone identifier. Communication between the reservation device and the base station is via the repeater which is located in the same zone as the communal item. The repeater receives the service request signal from the reservation device and passes the service request signal to the base station. The repeater measures the signal strength of the service request signal received from the reservation device, and adds the signal strength to the service request signal before it is passed to the base station. The repeater also adds the zone identifier of the repeater to the service request signal before it is passed to the base station.

In accordance with another embodiment, the base station is capable of sending the reservation device an information message.

In accordance with another embodiment, the reservation device includes a reserve activator. When activated, the reserve activator (1) causes the reservation device to enter the reserved state, (2) causes a communal item reserved signal to be sent from the reservation device to the base station, and (3) enables the timer activator.

In accordance with another embodiment, the reservation device includes a service state. The reservation device includes a service activator. When activated the service activator causes the reservation device to enter the service state and sends a service request signal from the reservation device to the base station.

In accordance with another embodiment, the reservation device includes a service activator. When activated the service activator causes the reservation device to enter the service state and causes a service request signal to be sent from the reservation device to the base station. The reservation device includes a system status display which when in the service state displays (1) a service message, and (2) a communal item identifier.

In accordance with another embodiment, the timer activator includes a motion sensor which senses movement of the communal item when the reservation device is connected thereto. When in the reserved state, if no movement of the communal item is sensed within a time interval, the timer activator causes the timer to start. Once started if the timer runs for the full period of time without the motion sensor sensing movement of the communal item, the reservation device changes from the reserved state to the available state.

In accordance with another embodiment, the timer activator includes a motion sensor which senses movement of the communal item. When in the reserved state, if no movement of the communal item is sensed within a time interval, the timer activator causes the timer to start. If movement is sensed before the period of time has elapsed, the timer stops and is reset.

In accordance with another embodiment, the reservation device includes a system status display which when the reservation device is in the reserved state displays a reserved message.

In accordance with another embodiment, the system status display is also capable of displaying a time generated by the timer.

In accordance with another embodiment, the reservation device includes a system status display which when the reservation device is in the available state displays an available message, and optionally a communal item identifier.

In accordance with another embodiment, the reservation device includes a timer reset function which when activated resets the timer.

Other embodiments, in addition to the embodiments enumerated above, will become apparent from the following detailed description, taken in conjunction with the accompanying drawings, which illustrate, by way of example, the principles of the reservation system, apparatus, and method of use.

### BRIEF DESCRIPTION OF THE DRAWINGS

FIG. 1 is a reduced perspective view of a timer for reserving occupancy of a communal item with the timer connected to a communal item;

FIG. 2 is a perspective view of the timer with a communal item available indicator in an extended position;

FIG. 3 is a perspective view of the timer with the communal item available indicator in a retracted position;

FIG. 4 is front elevation view of the timer with the communal item available indicator in the extended position;

FIG. 5 is a front elevation view of the timer with the communal item available indicator in the retracted position;

FIG. 6 is a fragmented front elevation view of the timer connected to the communal item;

FIG. 7 is a front elevation view of the timer with a service request indicator in an extended position;

FIG. 8 is a top plan view of the timer with a plurality of service request indicators;

FIG. 9 is a front elevation view of the timer with an enabling transaction feature;

FIG. 10 is block diagram of the timer;

FIG. 11 is a front elevation view of a second embodiment of the timer;

FIG. 12 is a block diagram of the second embodiment timer;

FIG. 13 is a reduced fragmented front perspective view of a reservation device for reserving occupancy of a communal item with the reservation device connected to a communal item;

FIG. 14 is a reduced fragmented rear perspective view of the reservation device connected to the communal item;

FIG. 15 is a reduced perspective view of the reservation device connected to a different style communal item;

FIG. 16 is front perspective view of the reservation device;

FIG. 17 is a rear perspective view of the reservation device;

FIG. 18 is a top plan view of the reservation device;

FIG. 19 is a front elevation view of the reservation device;

FIG. 20 is a bottom plan view of the reservation device;

FIG. 21 is a side elevation view of the reservation device;

FIG. 22 is an opposite side elevation view of the reservation device;

FIG. 23 is a reduced exploded perspective view of the reservation device;

FIG. 24 is a perspective view of a repeater;

FIG. 25 is a front elevation view of the reservation device in a reserved state;

FIG. 26 is a front elevation view of the reservation device in an available state;

FIG. 27 is a front elevation view of the reservation device in a service state;

FIG. 28 is a block diagram of the reservation device; and,

FIG. 29 is a block diagram of a reservation system.

### DETAILED DESCRIPTION OF THE INVENTION

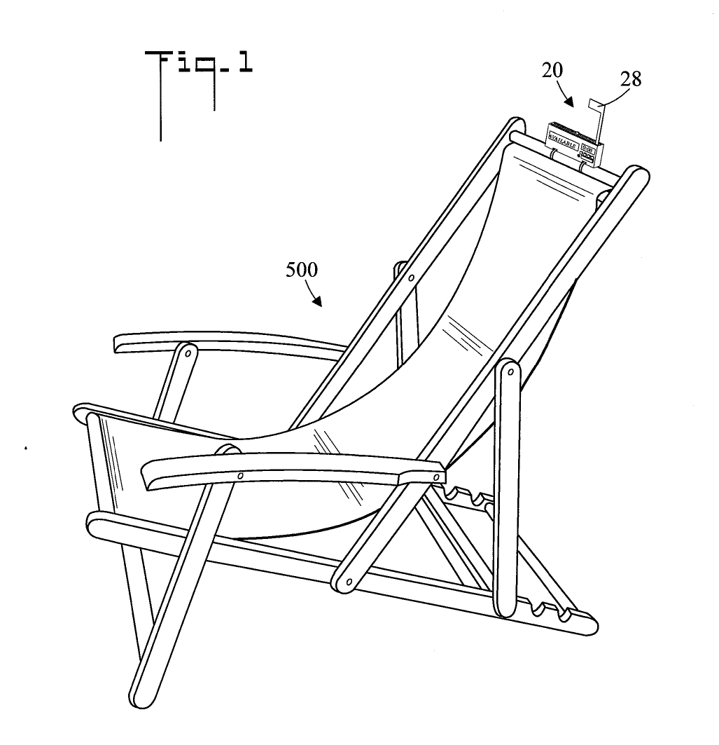

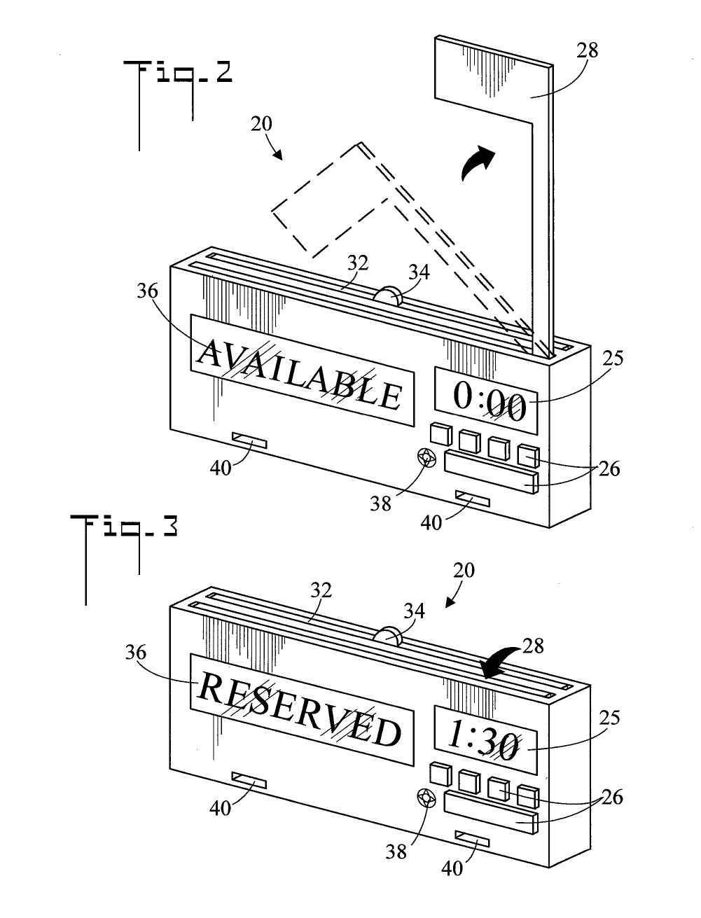

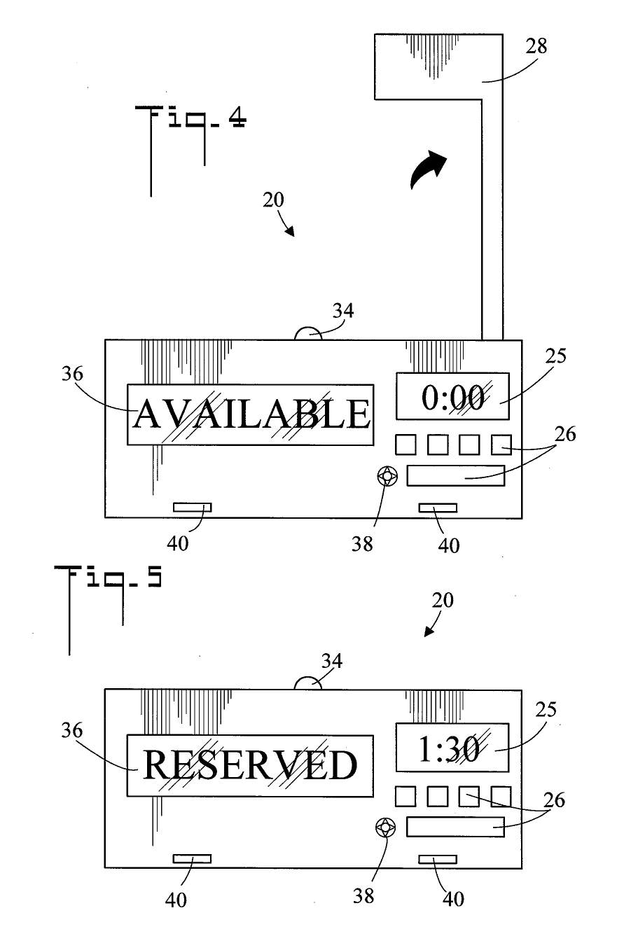

Referring initially to FIG. 1, there is illustrated a reduced perspective view of a timer 20 for reserving occupancy of a communal item 500 with timer 20 connected to communal item 500. FIGS. 2-3 are perspective views of timer 20, and FIGS. 4-5 are front elevation views of timer 20. Timer 20 is removably connectable to communal item 500, and is used to regulate how long a particular user can use communal item 500. As used herein the term “communal item” embraces any item which is provided for use by multiple users, and which is used by a particular user for a period of time.

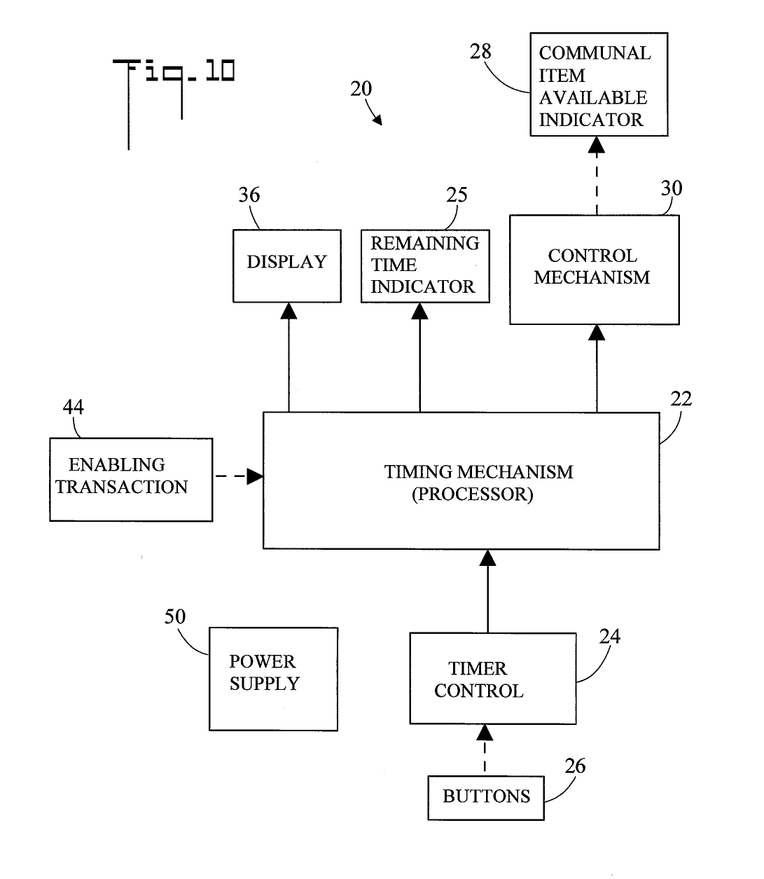

Also referring to FIG. 10, timer 20 includes a timing mechanism 22 which is settable to run for a period of time, and a timer control 24 which is used to set the period of time. In the shown embodiment, timing mechanism 22 includes a digital processor, and timer control 24 includes a plurality of control buttons 26 which are disposed on the face of timer 20. Control buttons 26 are used to set timing mechanism 22 to run for a desired period of time, and can be used to perform other timing-related actions (e.g. on/off, stop, reset, etc.). In one embodiment the setting of timer mechanism 22 is limited to a maximum period of time (e.g. 15 minutes, one hour, etc.). This ensures that communal item 500 will not be monopolized and will be available for another user. In the shown embodiment, a remaining time indicator 25 indicates the amount of time remaining before the set time period expires (i.e. remaining time indicator 25 counts down from the remaining time to zero).

Timer 20 further includes a communal item available indicator 28 which is positionable to (1) a retracted position (physically within the housing of timer 20) during the period of time, and (2) to an upwardly extended position after the period of time has expired. In the shown embodiment, communal item available indicator 28 includes a flag on a pole which pivots between the retracted position of FIG. 3, and in the extended position of FIGS. 2 and 4. Communal item available indicator 28 is biased (such as through spring loading) to the extended position.

Referring also to FIG. 10, a control mechanism 30 such as a latch holds communal item available indicator 28 in the retracted position during the period of time (i.e. during the time communal item 500 is reserved). When the set period of time has expired, control mechanism 30 causes communal item available indicator 28 to move to the extended position. That is, control mechanism 30 releases communal item available indicator 28 when the period of time has expired so that communal item available indicator 28 is urged by spring loading to the extended position.

Referring also to FIG. 7, timer 20 further includes a service request indicator 32 which is positionable to (1) a retracted position, and (2) an extended position. The extended position indicates that a service such as food, drink, or other amenity is requested. In the shown embodiment service request indicator 32 is flag which is manually positioned by the user, and has a tab 34 which facilitates gripping.

It may be appreciated that communal item available indicator 28 and service request indicator 32 could have shapes or forms other than that of a flag and pole. Also, the communal item available indicator 28 and service request indicator 32 could be colored and/or display indicia. And, timer 20 could produce an audible sound when time has expired to provide a second indicator (in addition to visible the flag) for notifying when time has expired.

Timer 20 further includes a display 36 which is capable of displaying a first message during the period of time, and a second message after the period of time has expired. As such, display 36 works in conjunction with communal item available indicator 28 to convey the occupancy status of the communal item. In the shown embodiment, the first message is a reserved message (RESERVED), and the second message is an available message (AVAILABLE). Display 36 can be a LCD display or other similar electronic display. As used herein the term “RESERVED” and “AVAILABLE” are intended to embrace any similar terminology which means that communal item 500 is in use or not in use respectively (e.g. occupied, in use, free, open, not in use, etc.).

In another embodiment, display 36 is capable of showing a message in grayscale or different colors, and may flash to produce an enhanced visual impact. Also, display 36 could display other messages or phrases not related to the reserved or available status of communal item 500.

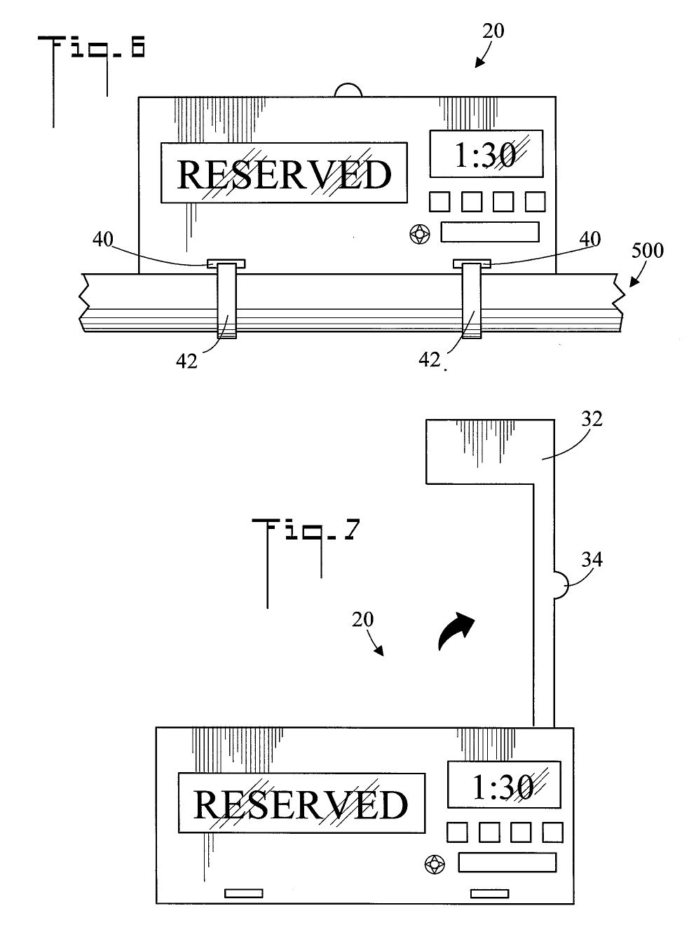

In the shown embodiment, the various components of timer 20 are disposed in/on a housing which is both weather and shock resistant. Moreover, timer 20 can be manufactured in a variety of sizes, shapes, colors, and designs depending on the intended use. Attachment of the housing to communal item 500 can be effected by numerous means as is discussed below under FIG. 6.

In an embodiment, once timing mechanism 22 has begun to run it is not resettable to a lower remaining time. This feature prevents a person who has not reserved communal item 500 from resetting timing mechanism 22 in order to expedite the availability of the communal item 500. For example, if a reserving user briefly steps away from a reserved communal item 500, another person could not seize that opportunity to lower the remaining time. In another embodiment, timer control 24 includes a reset control which interrupts the running of timing mechanism 22 and allows resetting of timing mechanism 22 to a lower remaining time. However, the reset control requires a key to effect resetting to a lower remaining time. For example, this feature is useful if the reserving user decides to abandon communal item 500 before the set time period has expired. In this case, the time could be reset to zero so that the next user would not have to start occupancy with a low remaining time. In an embodiment the key is a specially designed mechanical key which fits a specially designed receptacle 38 on the face of timer 20 (refer to FIGS. 2-5). Alternatively, the key could comprise a code which is entered using control buttons 26 (e.g. a specified sequence of button activation which enables the reset feature). The key would typically be in the possession of a person other than the user (such as a pool or gym attendant) who is authorized to perform the resetting, and when requested can do so for any communal item 500.

In another embodiment, once timing mechanism 22 has begun to run it is not resettable to a higher remaining time. This feature prevents a user from resetting timing mechanism 22 in order to prolong occupancy of communal item 500. In another embodiment, timer control 24 includes a reset control which interrupts the running of timing mechanism 22 and allows resetting of timing mechanism 22 to a higher remaining time, however as in the case of the lower time reset discussed above, the reset requires a key to effect the resetting to a higher remaining time. This feature is useful when there is no one currently waiting to use communal item 500, and the present user desires to extend the reserved time.

FIG. 6 is a fragmented front elevation view of timer 20 connected to communal item 500. The connection can be effected by numerous connection means such as hook and loop fasteners, clips, straps, snap fit fasteners, magnets, ties, adhesives, and the like. In the shown embodiment, timer 20 includes two slots 40 each of which receives a connecting strap 42. Alternatively, timer 20 can simply be carried and placed on or near communal item 500 with positive mounting not required.

FIG. 7 is a front elevation view of timer 20 with service request indicator 32 in an extended position. In the shown embodiment, service request indicator 32 is a flag on a pole which pivots to the extended and retracted positions. Tab 34 is used to pivotally rotate service request indicator 32 to the extended (service requested) position.

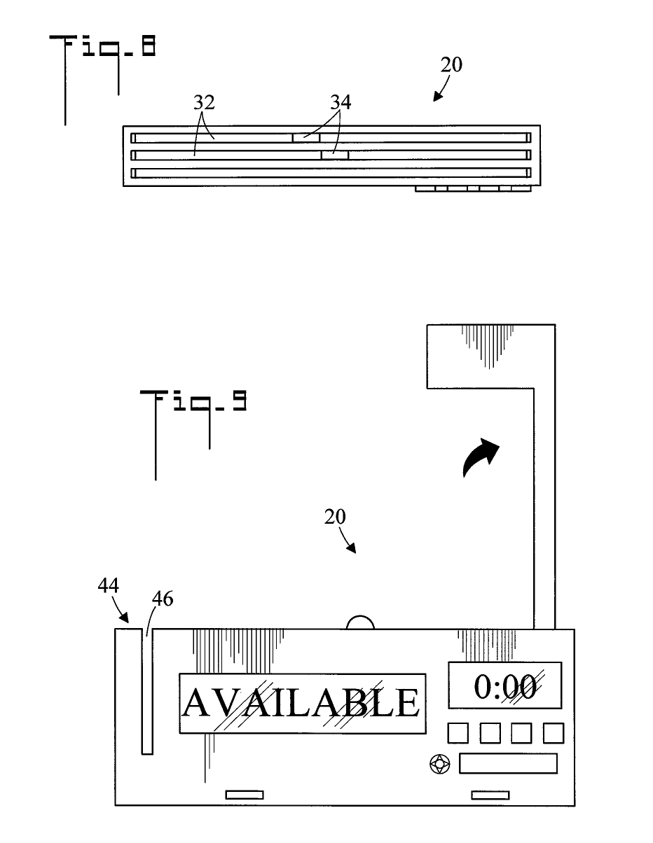

FIG. 8 is a top plan view of timer 20 which has a plurality of service request indicators 32 and associated tabs 34. Service request indicators 32 could be different colors to indicate which service is requested (e.g. drinks, food, etc).

FIG. 9 is a front elevation view of the timer with an enabling transaction 44 feature (also refer to FIG. 10 and the associated discussion). In this embodiment an enabling transaction such as the swipe of a room card is required to operate timer 20. The room card is passed through a card-reader slot 46 in timer 20. Timer 20 reads the room card and, if valid, enables operation of timer 20 through timer control 24.

FIG. 10 is block diagram of timer 20. In the shown embodiment, timer 20 includes timing mechanism 22, timer control 24, remaining time indicator 25, communal item available indicator 28, control mechanism 30, display 36, enabling transaction 44, and power supply 50. In the diagram (and in FIG. 12) electrical connections are shown with a solid arrow and mechanical connections or actions are shown with a dashed arrow. The timing mechanism 22, timer control 24, remaining time indicator 25, and power supply 50 features of timer 20 comprise a digital timer which is well known in the art. Timing mechanism 22 is a microprocessor which receives a time set input from timer control 24. Control buttons 26 of timer control 24 permit a user to set a desired period of time during which communal item 500 will be reserved. The set time period is initially displayed on remaining time indicator 25 which then counts down as the set time period elapses. Timing mechanism 22 sends a signal to display 36 which causes a message such as RESERVED to appear. When the time period expires, timing mechanism 22 sends a signal to control mechanism 30 which in turn causes control mechanism 30 to activate available indicator 28.

In one embodiment control mechanism 30 is a latch which releases spring loaded available indicator 28 (a flag) allowing it to pivot to an extended position (refer to FIGS. 1, 2, and 4) thereby indicating that communal item 500 is available for another user. Also, timing mechanism 22 sends a signal to display 36 which causes a message such as AVAILABLE to appear.

In the shown embodiment, timer 20 also includes an enabling transaction 44 feature. The user is required to perform an enabling transaction before timing mechanism 22 will operate. For example enabling transaction 44 could be a card reader 46 (refer to FIG. 9), and before timing mechanism 22 can be set, the user's room card (key) must be passed through card reader 46. Alternatively, enabling transaction 44 could accommodate financial transactions, wherein credit cards, coins, or special tokens would be used to activate timing mechanism 22.

Power supply 50 is typically a battery, but could also be an electrical outlet or a solar power source.

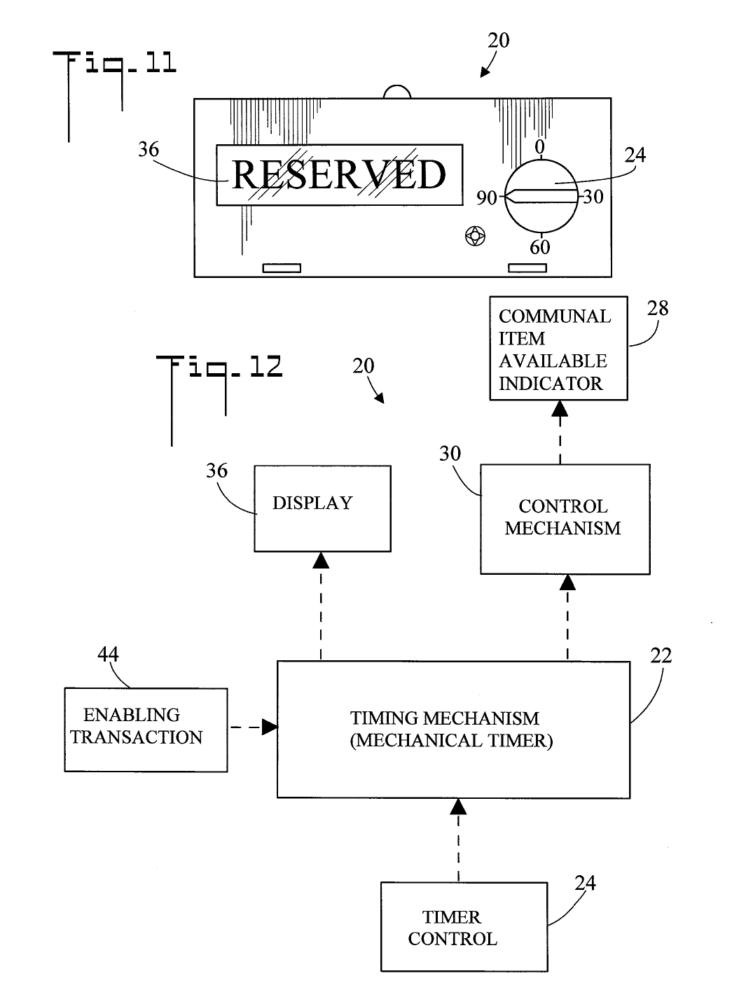

FIG. 11 is a front elevation view of a second embodiment of timer 20, and FIG. 12 is a block diagram of the second embodiment. In this embodiment timing mechanism 22 and timer control 24 comprise a mechanical timer which is well know in the art (U.S. Pat. Nos. 2,696,899 and 7,484,882 are examples of mechanical timer technology). Timer control 24 is a rotary knob which allows the user to set a desired time period (e.g. 90 minutes). Timing mechanism also causes display 36 to display a RESERVED message. Timing mechanism 22 then mechanically counts down time until the set time period expires. At expiration timing mechanism 22 sends a signal to control mechanism 30 which in turn causes available indicator 28 to move to the extended position indicating that communal item 500 is available for another user. Timing mechanism 22 also causes display 36 to display an AVAILABLE message. In this embodiment enabling transaction 44 could accept coins or tokens.

In another embodiment, timer 20 and communal item 500 are combined to form a reservation system for reserving occupancy of communal item 500.

In another aspect, timer 20 reserves occupancy of communal item 500 both when the user is actually using communal item 500, and when the user has temporarily stepped away from communal item 500. That is, occupancy remains reserved regardless of the physical presence of the user.

In addition to the previously mentioned examples, timer 20 can be used in a variety of other situations some of which are outlined below:
Beach chairs, umbrellas & tables to prevent “chair hogging”
Parks to reserve picnic tables, shelter houses etc
Crowded restaurants where there is a wait for a table, this would limit/monitor the amount of time one party occupies a table
To regulate the amount of time spent on gym equipment such as cardio machines in a busy or crowded gym when guests are waiting to use an available machine or piece of equipment
To regulate time usage of a limited number of computers in a crowded computer lab
To regulate the time spent by children playing in or on a toy or amusement park/fair attraction (eg: bounce house)

In addition to limiting the period of use of a communal item as described above, the present invention can also be used to limit the duration of reservation of a communal item when the communal item is not in use. That is, if the communal item is unoccupied or not in use, but personal articles are disposed in the area of the communal item in order to reserve the communal item, the present invention can be used to limit the practice of reserving the communal item for an indefinite amount of time where the individual is not occupying or utilizing the communal item.

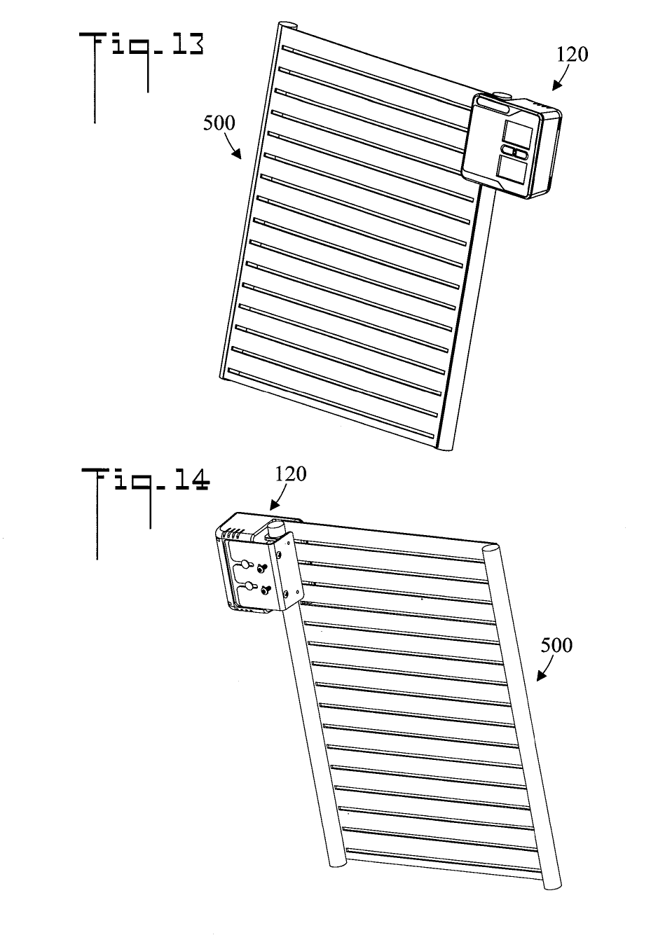

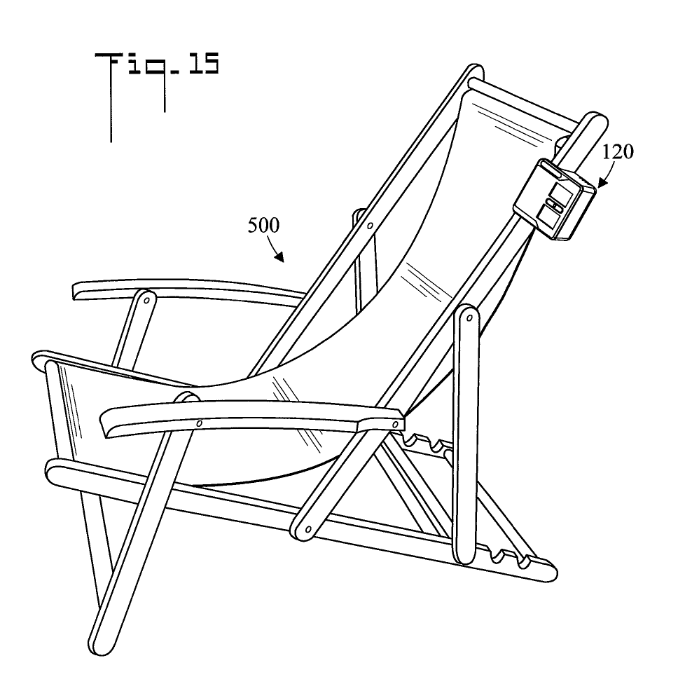

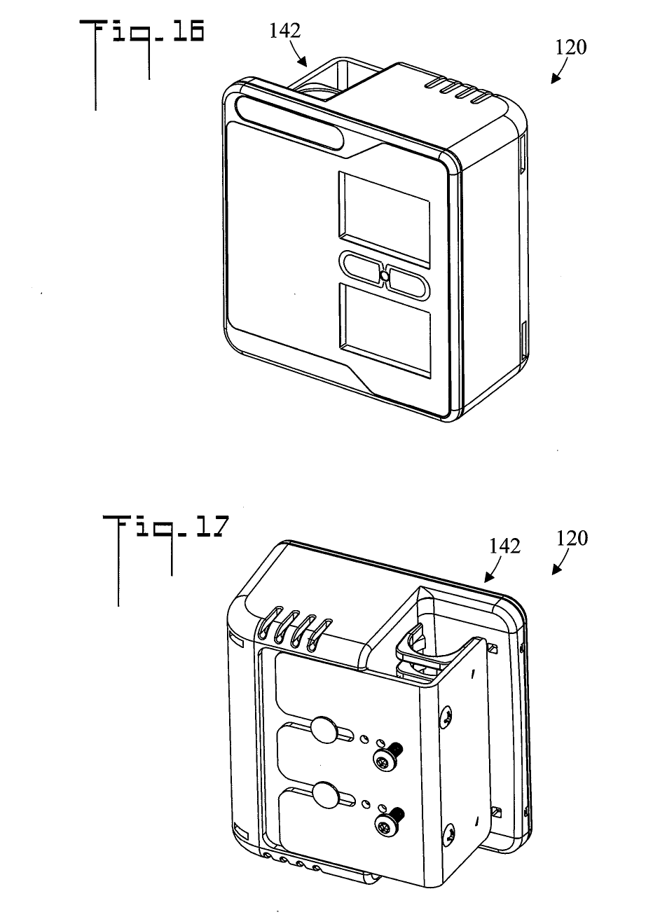

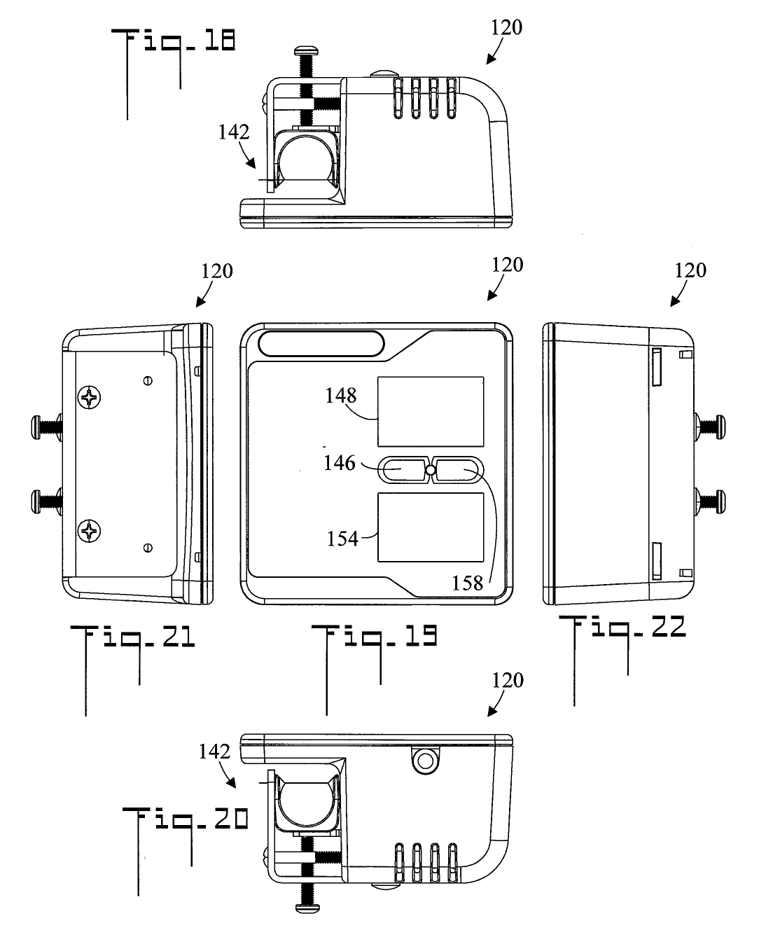

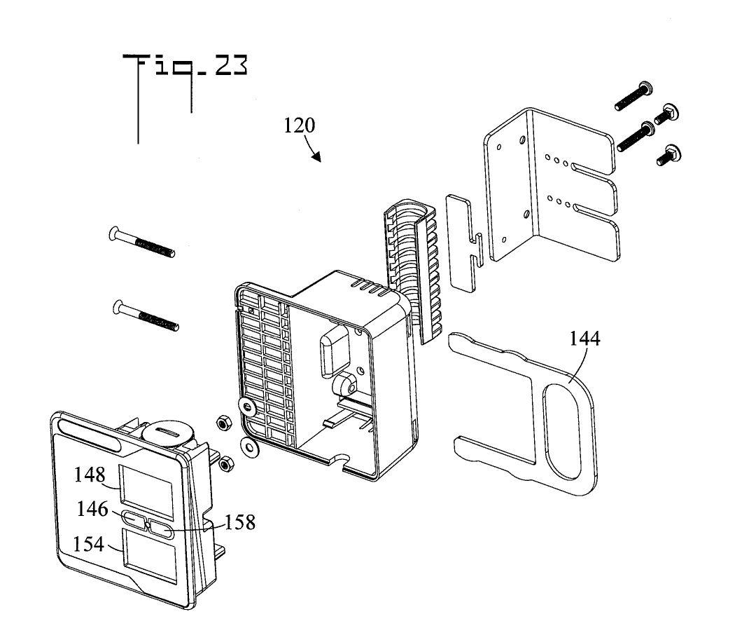

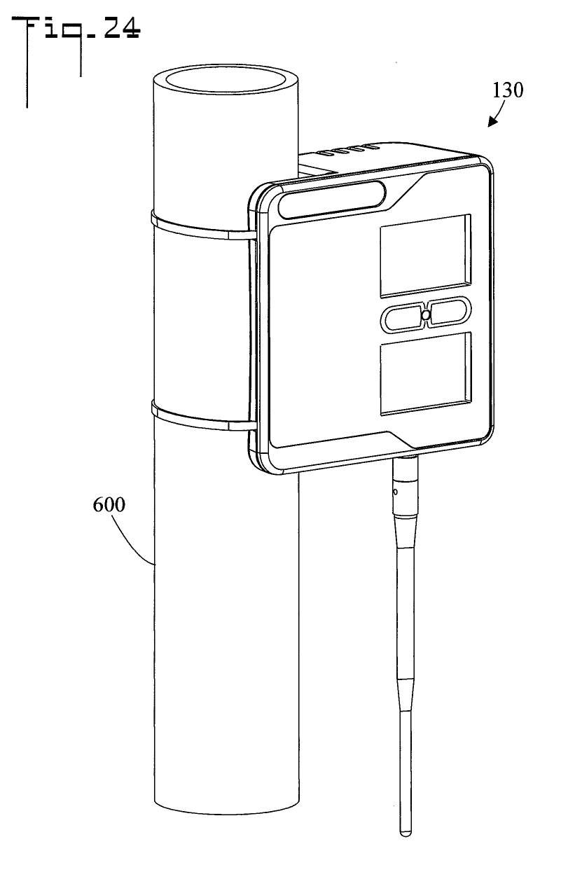

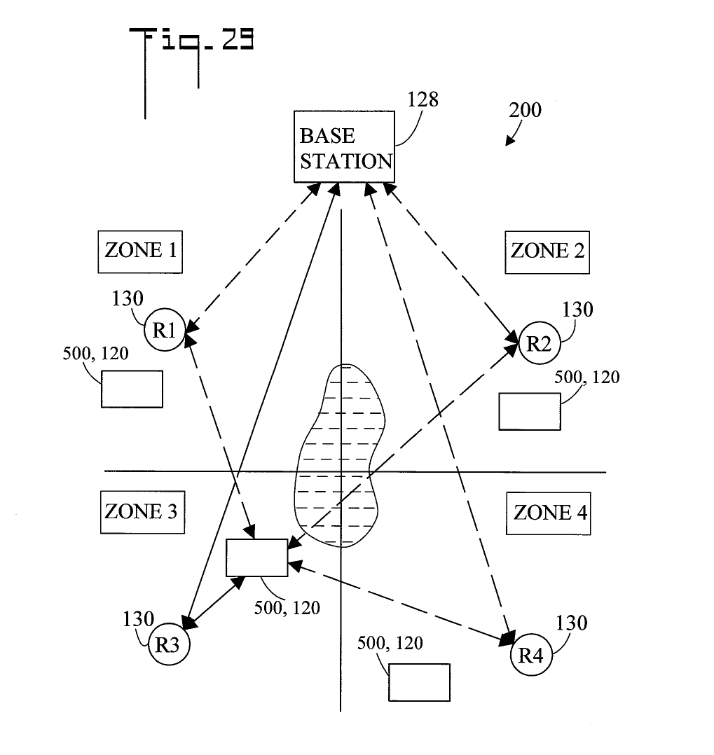

Referring to FIG. 13 there is illustrated a reduced fragmented front perspective view of a reservation device 120 for reserving occupancy of a communal item 500 with the reservation device 120 connected to communal item 500. FIG. 14 is a reduced fragmented rear perspective view of reservation device 120 connected to communal item 500. FIG. 15 is a reduced perspective view of reservation device 120 connected to a different style communal item 500. FIGS. 16-23 show various views of reservation device 120. FIG. 28 is a block diagram of reservation device 120, and FIG. 29 is a block diagram of a reservation system 200 for reserving occupancy of communal item 500. In the shown embodiment, communal item 500 is a chair which can be occupied by a user. It is noted that in FIGS. 13-14 only the upper portion of the chair is illustrated. As used herein the term “communal item” embraces any item which is provided for use by multiple users, which is used by a particular user for a period of time, and includes communal items 500 in which the user sits or otherwise rests upon the communal item 500 (e.g. chairs, lounge chairs, stools, beds, etc.).

Reservation system 200 includes a communal item placement area (such as around a swimming pool, on the deck of a ship, etc.) which is divided into a plurality of zones (Zones 1-4 in the embodiment shown in FIG. 29). Communal item 500 is disposed in the communal item placement area, and resides in one of the plurality of zones. Reservation system 200 further includes reservation device 120 which is connectable to communal item 500. In the shown embodiment of FIGS. 13 and 14, reservation device 120 attaches to a side member which forms the upper portion of the chair.

Reservation device 120 includes an available state in which communal item 500 is available for use, and a reserved state in which communal item 500 is reserved. Referring to FIG. 28, reservation device 120 further includes a timer 122 which runs for a period of time (e.g. 60 minutes, or another period of time as defined by facility personnel), and a timer activator 124 which starts timer 122. In the shown embodiment of FIG. 28, timer 122 is implemented within a microcontroller 126.

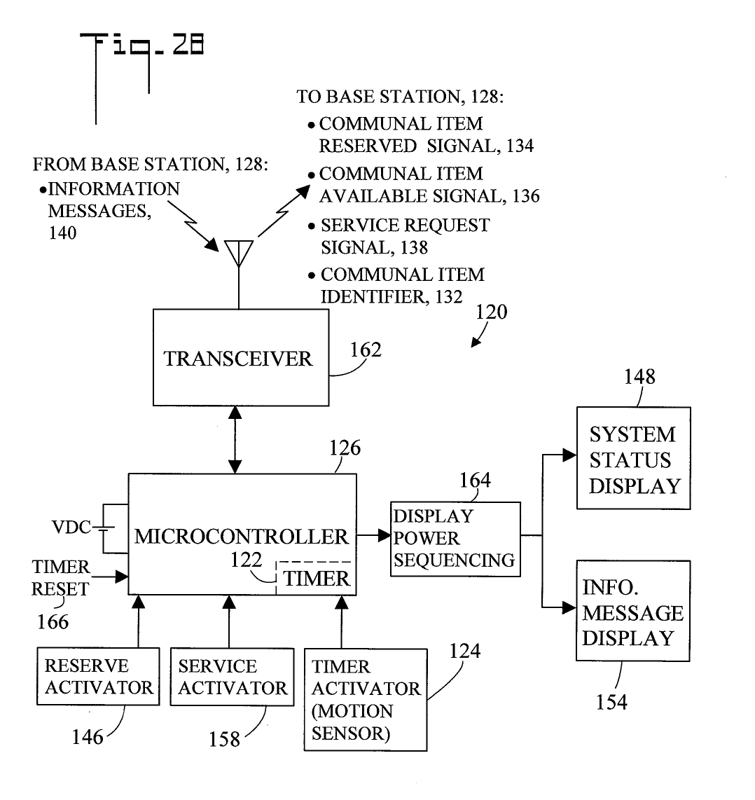

Again referring to FIG. 28, timer activator 124 includes a motion sensor (such as an accelerometer) which senses movement of communal item 500 when reservation device 120 is connected thereto. The movement of communal item 500 is caused by the movement of the user who is occupying communal item 500. When in the reserved state, if no movement of communal item 500 is sensed within a time interval, timer activator 124 causes timer 122 to start. In an embodiment the time interval is five minutes, however other time intervals could also be utilized. That is, if the user vacates a reserved communal item 500 for five minutes, no movement will be sensed, and timer 122 will start a 60 minute countdown. Once started if timer 122 runs for the period of time (i.e. counts down the entire 60 minutes) without the motion sensor sensing movement of communal item 500, reservation device 120 changes from the reserved state to the available state (also refer to FIGS. 25 and 26 respectively). At this point the user's personal items could be removed from communal item 500 by facility personnel (those individuals who manage and operate reservation system 200) allowing another user to utilize communal item 500. In another embodiment, if movement is sensed before the period of time has elapsed, timer 122 is reset. That is, if the user returns and reoccupies communal item 500 before the period of time has elapsed (e.g. is gone for less than 60 minutes), then timer 122 stops counting and is reset. Reset means that timer 122 is again ready to begin counting down should the user again vacate communal item 500 for longer than the time interval. The motion sensor feature serves to relieve the user of the chore of manually re-setting reservation device 120 on a continual basis. It is noted that timer 122 can either countdown from the period of time (e.g. countdown from 60 minutes to zero minutes), or alternatively could count up from zero minutes to the time period (e.g. count up from zero minutes to 60 minutes).

Referring to FIGS. 28 and 29, reservation system 200 further includes a base station 128 which is controlled and operated by facility personnel. In an embodiment, base station 128 comprises a computer system which provides the current status of reservation system 200. Reservation device 120 is capable of wirelessly communicating with base station 128. In an embodiment a mesh wireless network is utilized to effect bi-directional wireless communication between reservation device 120 and base station 128. A mesh wireless network is well known in the art, and is a communication network which includes a plurality of radio frequency nodes which are arranged in a mesh topology. Various status and control signals are sent from reservation device 120 to base station 128, and information messages (such as notices or advertisements) are sent from base station 128 to reservation device 120. For example, reserved, available, and service request signals along with a communal item identifier (i.e. a unique identifier for each communal item) are sent from reservation device 120 to a computer at base station 128. This information provides facility personnel with an up-to-date status of each communal item 500 in the reservation system 200.

Referring to FIG. 29, each of the plurality of zones has a repeater 130. Communication between reservation device 120 and base station 128 is via the repeater 130 which is located in same zone as communal item 500. For example, communal item 500 and associated reservation device 120 located in zone 3 communicates with base station 128 via repeater R3 which is located in zone 3. This is the primary communication path and is shown in solid lines. It is noted however that the reservation device 120 located in zone 3 also communicates with base station 128 via the repeaters 130 located in other zones (shown in dashed lines). This multiple communication path feature provides communication redundancy and is an inherent characteristic of mesh wireless networks. In the embodiment shown in FIG. 28, a plurality of communal items 500 are disposed in the communal item placement area. Reservation system 200 includes the previously mentioned mesh wireless network wherein each of the repeaters 130 communicate with (1) base station 128, (2) other repeaters 130, and (3) multiple reservation devices 120 which can be connected to multiple communal items 500.

Referring to FIGS. 28 and 29, each reservation device 120 has a unique communal item identifier 132 (e.g. communal item #001). Reservation device 120 is capable of sending base station 128 a communal item reserved signal 134 which includes the communal item identifier 132. Further, each repeater 130 has a unique zone identifier. For example, the repeater in zone 3 would have a zone identifier of 3. In a primary mode of operation, the communication between reservation device 120 and base station 128 is via the repeater 130 which is located in the same zone as communal item 500. Repeater 130 receives communal item reserved signal 134 from reservation device 120 and passes communal item reserved signal 134 to base station 128. Repeater 130 measures a signal strength of communal item reserved signal 134 received from reservation device 120, and adds the signal strength to communal item reserved signal 134 before it is passed to base station 128. Repeater 130 also adds the zone identifier of the repeater 130 to communal item reserved signal 134 before it is passed to base station 128. It is noted however, that other repeaters 130 can also transmit reserved signal 134 (or any other signal from reservation device 120) to base station 128. Base station 128 then compares the signal strength from all repeaters 130, and determines which repeater 130 is closest to the transmitting reservation device 120, and therefore in which zone the communal item 500 is located. For example in FIG. 29, since communal item 500/reservation device 120 is located in zone 3, due to a shorter transmission distance, the signal strength coming from the repeater 130 in zone 3 would be higher than that of the other repeaters 130. As such, base station 128 determines that the transmitting reservation device 120 is located in zone 3. This zone location information in addition to the communal item identifier 132 assists facility personnel in physically locating a particular communal item 500.

Again referring to FIGS. 28 and 29, reservation device 120 is also capable of sending base station 128 a communal item available signal 136 which includes communal item identifier 132. Repeater 130 receives communal item available signal 136 from reservation device 120 and passes the communal item available signal 136 to base station 128. As with the previously discussed communal item reserved signal 134, repeater 130 measures the signal strength of the communal item available signal 136 received from reservation device 120, and adds the signal strength to the communal item available signal 136 before it is passed to base station 128. Repeater 130 also adds the zone identifier of repeater 130 to the communal item available signal 136 before it is passed to base station 128.

Still referring to FIGS. 28 and 29, reservation device 120 is also capable of sending base station 128 a service request signal 138 which includes communal item identifier 132. Repeater 130 receives the service request signal 138 from reservation device 120 and passes the service request signal 138 to base station 128. As with the reserved signal 134 and available signal 136, repeater 130 measures the signal strength of service request signal 138 received from reservation device 120, and adds the signal strength to the service request signal 138 before it is passed to base station 128. Repeater 130 also adds the zone identifier of repeater 130 to the service request signal 138 before it is passed to base station 128.

Referring to FIG. 28, base station 128 is capable of sending reservation device 120 an information message 140. The information message 140 can be an advertisement, a special offer, a public notice, event schedules, or any other information which facility personnel deems appropriate. The messages are displayed on an information messages display located on reservation device 120 (refer to FIGS. 25-27).

Referring to FIGS. 13-22, in the shown embodiment reservation device 120 is connected to communal item 500 by a clamping mechanism 142 wherein reservation device 120 is removably clamped around a structural member of communal item 500. Clamping mechanism 142 is designed to accommodate a variety of communal item shapes, sizes, and styles. It may be appreciated however that other methods of connecting reservation device 120 to communal item 500 could also be employed.

It is noted in FIG. 23, that reservation device 120 includes a removal key 144. This unique tool fits into the housing of reservation device 120, and enables facility personnel to easily remove the electronics components disposed therein.

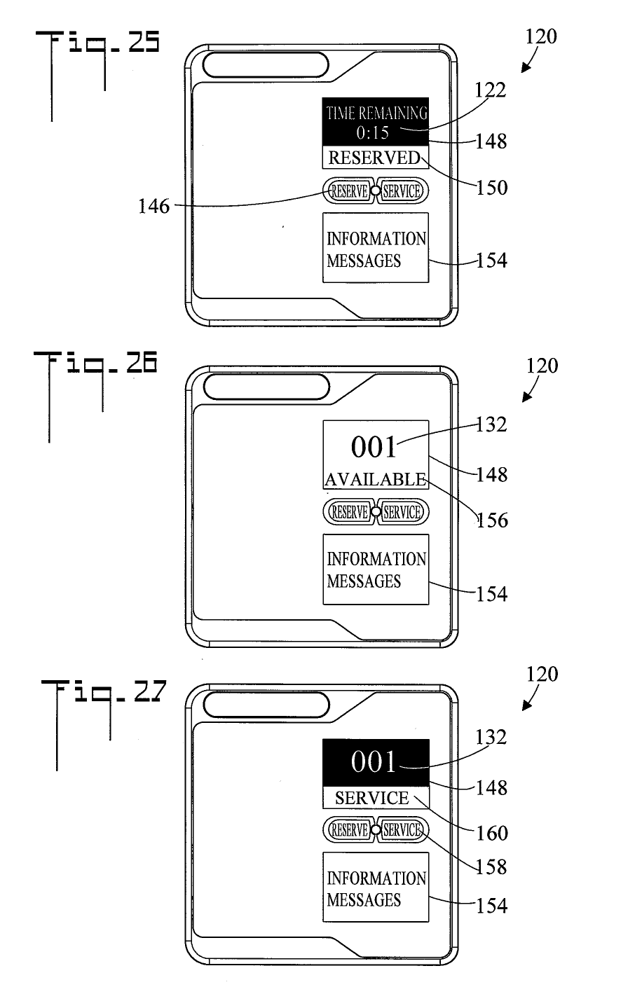

FIG. 24 is a perspective view of repeater 130. Repeater 130 is unobtrusively mounted to a structure such as the shown pole 600, and relays signals between reservation device 120 and base station 128 (refer to FIG. 29). Repeaters 130 are located in each of the zones of the communal item placement area.

FIG. 25 is a front elevation view of reservation device 120 in the reserved state. Reservation device 120 includes a system status display 148 which when reservation device 120 is in the reserved state displays a reserved message 150. Reservation device 120 includes a reserve activator 146. Reserve activator 146 can be a button, a switch, a touchscreen, or the like. When activated by a user (such as by pressing), reserve activator 146 starts system operation and specifically (1) causes reservation device 120 to enter the reserved state, (2) causes a communal item reserved signal 134 (refer to FIG. 28) to be sent from reservation device 120 to base station 128 (refer to FIGS. 29), and (3) enables timer activator 124. Enabling timer activator 124 means that once reserve activator 146 is activated, timer activator 124 will cause timer 122 to start counting if motion is not sensed for the time interval (e.g. five minutes). It is noted that when in the reserved state, system status display 148 is also capable of displaying a time generated by timer 122. The time generated by timer 122 is only displayed when the timer 122 has been started and is counting as a result of the user vacating communal item 500. Reservation device 120 further includes an information message display 154 for displaying messages received from base station 128. Information display message display 154 can be used when reservation device 120 is in the reserved state, the available state, or service state.

In an embodiment, system status display 148 and information message display 154 are bistable graphic LCD displays wherein power is only required to change the display image. This greatly reduces the power consumption of reservation device 120. Further, the displays are designed to be seen in bright sunlight.

FIG. 26 is a front elevation view of reservation device 120 in the available state. When in the available state, system status display 148 displays (1) an available message 156, and (2) communal item identifier 132 (e.g. communal item #001).

FIG. 27 is a front elevation view of reservation device 120 in the service state. Reservation device 120 includes a service activator 158. As with reserve activator 146, service activator can be a button, a switch, a touchscreen, or the like. When activated service activator 158 causes reservation device 120 to enter the service state and sends a service request signal 138 from reservation device 120 to base station 128 (refer to FIG. 29). When in the service state system status display 148 displays (1) a service message 160, and (2) a communal item identifier 132. It is noted that in an embodiment, the service state can only be entered if reservation device 120 has first been placed in the reserved state.

FIG. 28 is a block diagram of reservation device 120. The functions of reservation device 120 are implemented by microcontroller 126. It may be appreciated however that other computational elements such as microprocessor could also be utilized. Microcontroller 126 can be powered by a battery, or could be solar powered. A transceiver 162 effects communication between microcontroller 126 and base station 128. As previously discussed, reserve activator 146 and service activator 158 are inputs provided by a user. Timer activator 124 such as a motion sensing accelerometer enables timer 122, which after not detecting motion for a time interval starts running. A display power sequencing unit 164 drives system status display 148 and information message display 154. Reservation device 120 further includes a timer reset function 166, which when activated resets timer 122 to zero returning reservation device 120 to the available state. In an embodiment timer reset function 166 comprises activating reserved activator 146 and service activator 158 in a particular sequence, such as by activating both activators simultaneously. In an embodiment, timer reset function 166 is only used by facility personnel.

FIG. 29 is a block diagram of reservation system 200 showing the communal item placement area divided into zones 1-4, a plurality of repeaters 130, a plurality of communal items 500 and associated reservation devices 120, and base station 128. Base station 128 consists of a computer system and display. Base station 128 is located in a convenient location allowing facility personnel to manage reservation system 200 from base station 128. Base station 128 receives information from reservation device 120 via repeaters 130 and is also capable of creating and sending information messages to the individual reservation devices 120. Base station 128 is also utilized to configure reservation system 200 and reservation device 120 mapping upon initial set-up. Base station 128 allows facility personnel to monitor available communal items, reserved communal items and the status of service requests.

In another embodiment, as an alternative to guests reserving a communal item via activating the “reserve” activator on reservation device 120, it is possible that guests could reserve a particular communal item 500 via a web-based platform or mobile application that communicates with individual reservation devices 120 within reservation system 200.

### Operational Scenarios:

A discussion of various operational scenarios for reservation system 200 is provided below. In these scenarios, the communal item is a lounge chair:

### Scenario #1

A guest locates a chair, leaves the chair, and returns in less than 60 minutes.
1. A resort guest selects an unoccupied lounge chair with a reservation device which displays the word “AVAILABLE” on the system status display. The guest sets his/her personal items on the chair.
2. The guest presses the “Reserve” button to reserve the chair. The system status display changes to display the word “RESERVED”. The reservation device will then transmit a data packet containing a reserved signal and a communal item identifier. The reserved signal data packet will be received by repeaters located within range of the chair. The repeaters forward the reserved signal data packet to the base station along with a zone identifier of the repeater and the signal strength of the data packet. Base station software will detect which zone the chair is located in based on the repeater which receives the greatest signal strength. Base station software will then add the communal item identifier to the list of reserved chairs in a database.
3. The guest does not sit in the chair, but leaves the chair to go get their morning coffee. After the motion sensor senses no movement of the chair for five minutes, the timer begins counting down from 60 minutes.
4. As the timer counts down, the system status display will display “Time remaining: X:XX” (in hours: minutes). The system status display will refresh and display a new time each minute that the chair remains unoccupied.
5. When the guest returns to the chair and sits in the chair before the timer reaches “0:00”, the motion sensor will detect the movement of the chair and the timer will turn off/re-set. The system status display will continue to display “RESERVED”.
6. Steps #3-#5 can be repeated numerous times throughout the day.

### Scenario #2

A guest locates a chair, leaves the chair, and returns in >60 minutes.
1. A guest selects an unoccupied lounge chair with a reservation device which displays the word “AVAILABLE” on the system status display. The guest sets his/her personal items on the chair.
2. The guest presses the “Reserve” button to reserve the chair. The system status display changes to display the word “RESERVED”. The reservation device will then transmit a data packet containing a reserved signal and a communal item identifier. The reserved signal data packet will be received by repeaters located within range of the chair. The repeaters forward the data packet to the base station along with a zone identifier of the repeater and the signal strength of the reserved signal data packet. Base station software will detect which zone the chair is located in based on the repeater which receives the greatest signal strength. Base station software will then add the communal item identifier to the list of reserved chairs in the database.
3. The guest does not sit in the chair, but leaves the chair to go get their morning coffee. After the motion sensor senses no movement of the chair for five minutes, the timer begins counting down from 60 minutes.
4. As the timer counts down, the system status display will display “Time remaining: X:XX” (in hours: minutes). The system status display will refresh and display a new time each minute that the chair remains unoccupied.
5. The guest does not return within 60 minutes.
6. When the time expires (after 60 minutes); the system status display will change from “RESERVED” to “AVAILABLE”. The reservation device will then transmit a data packet containing an available signal and a communal item identifier. The available signal data packet will be received by repeaters located within range of the chair. The repeaters forward the available signal data packet to the base station along with a zone identifier of the repeater and the signal strength of the data packet. Base station software will detect which zone the chair is located in based on the repeater which receives the greatest signal strength. Base station software will then add the communal item identifier to the list of available chairs in the database.
7. The “AVAILABLE” message both on the system status display and at the base station will prompt facility personnel to remove the personal items left unattended for >60 minutes.

### Scenario #3

A guest utilizing a lounge chair desires service (eg: food or drink)
1. A guest selects an unoccupied lounge chair with a reservation device which displays the word “AVAILABLE” on the system status display. The guest sets his/her personal items on the chair.
2. The guest presses the “Reserve” button to reserve the chair. The system status display changes to display the word “RESERVED”. The guest occupies the chair and begins relaxing.
3. The guest utilizing the chair determines that they would like to place a food or beverage order with a facility staff member. The guest presses the “Service” button to call wait staff to their lounge chair so that an order may be placed.
4. The system status display then displays a large 3 digit number (communal item identifier), and the word “SERVICE”.
5. The reservation device will then transmit a data packet containing a service request signal and a communal item identifier. The service request signal data packet will be received by repeaters located within range of the chair. The repeaters forward the service request signal data packet to the base station along with a zone identifier of the repeater and the signal strength of the data packet. Base station software will detect which zone the chair is located in based on the repeater which receives the greatest signal strength. Base station software will then add the communal item identifier to the list of chairs awaiting service.
6. Wait staff will then locate the chair in the specified zone. When wait staff approaches the chair to take the guest's order, the wait staff will acknowledge the “Service” request and press a button on the reservation device to turn off the service request signal.

### Scenario #4

A guest reserves a lounge chair but does not place personal items on or near the chair.
1. The reservation device is in “RESERVED” state and time is counting down (see scenario #1); however, there are no personal items placed on or near the lounge chair, so it appears unoccupied.
2. Facility personnel use their discretion to determine whether to place the reservation device into the “AVAILABLE” state by “resetting” the device through the “Reset” function. (For example a pop up shower may have just passed and ran all of the pool guests out of the pool area resulting in several chairs in the reserved state which are no longer occupied. Therefore, facility personnel can reset the reservation device to the “AVAILABLE” state.)

### Scenario #5

A guest fails to start the reservation process.
1. A resort guest selects an unoccupied lounge chair with a reservation device which displays “AVAILABLE” on the system status display. The guests sets their personal items on the chair, but does not press the “Reserve” button.
2. If the guest leaves the chair without pressing the “RESERVE” button the chair will remain in the “AVAILABLE” state and facility personnel may remove the guest's personal items from the chair.

In terms of use, a method for a user to reserve occupancy of a communal item includes (refer to FIGS. 13-29):

(a) providing a communal item placement area;

(b) providing a communal item 500 disposed in the communal item placement area;

(c) providing a reservation device 120 which is connected to communal item 500, reservation device 120 including;
an available state in which communal item 500 is available for use;
a reserved state in which communal item 500 is reserved;
a timer 122 which runs for a period of time;
a timer activator 124 which starts timer 122;
a reserve activator 146 which when activated (1) causes reservation device 120 to enter the reserved state, and (2) causes timer activator 124 to be enabled;
a system status display 148 which when communal item 500 is available displays an available message 156, and when communal item 500 is reserved displays a reserved message 150;
reservation device 120 capable of wirelessly communicating with base station 128;

(d) the user ensuring that reservation device 120 is in the available state by observing that system status display 148 displays available message 156;

(e) the user activating reserve activator 146 thereby causing reservation device 120 to enter the reserved state, causing timer activator 124 to be enabled, and causing reserved message 150 to appear on system status display 148; and,

(f) the user occupying communal item 500.

The method further including:

providing a base station 128, reservation device 120 capable of wirelessly communicating with base station 128;

in (e), activating said reserve activator 146 also causing a communal item reserved signal 134 to be sent from reservation device 120 to base station 128.

The method further including:

in (c), timer activator 124 including a motion sensor which senses movement of communal item 500;

the user vacating communal item 500; after vacating communal item 500, if no movement of communal item 500 is sensed within a time interval, timer activator 124 causing timer 122 to start; and,

timer 122 running for the period of time without the motion sensor sensing movement of communal item 500, thereby causing reservation device 120 to change from the reserved state to the available state.

The method further including:

in (c), timer activator 124 including a motion sensor which senses movement of communal item 500;

the user vacating communal item 500; after vacating communal item 500, if no movement of communal item 500 is sensed within a time interval, timer activator 124 causing timer 122 to start; and,

the user reoccupying communal item 500 before the period of time has elapsed, thereby causing timer to stop and be reset.

The method further including:

in (c), reservation device 120 including a service state;

in (c), reservation device 120 including a service activator 158; and,

activating service activator 158 causing reservation device 120 to enter the service state and causing a service request signal 138 to be sent from reservation device 120 to base station 128.

The method further including:

in (c), reservation device 120 including a service state;

in (c), reservation device including a service activator 158;

in (c), reservation device including a system status display 148 which when in the service state displays (1) a service message 160, and (2) a communal item identifier 132; and,

activating service activator 158.

The method further including:

in (c), reservation device 120 including a timer reset function 166 which when activated resets timer 122; and,

facility personnel activating timer reset function 166.

The embodiments of the reservation system, apparatus, and method of use described herein are exemplary and numerous modifications, combinations, variations, and rearrangements can be readily envisioned to achieve an equivalent result, all of which are intended to be embraced within the scope of the appended claims. Further, nothing in the above-provided discussions and drawings of the reservation system, apparatus, and method of use should be construed as limiting the invention to a particular embodiment or combination of embodiments. The scope of the invention is best defined by the appended claims.

We claim:

1. A reservation system for reserving occupancy of a communal item, comprising:
a communal item placement area;
a communal item disposed in said communal item placement area;
a reservation device which is connectable to said communal item, said reservation device including;
an available state in which said communal item is available for use;
a reserved state in which said communal item is reserved;
a timer which runs for a period of time; and,
a timer activator which starts said timer.

2. The reservation system according to claim 1, further including:
a base station, said reservation device capable of wirelessly communicating with said base station.

3. The reservation system according to claim 2, further including:
said communal item placement area divided into a plurality of zones; and,
said communal item residing in one of said plurality of zones.

4. The reservation system according to claim 3, further including:
each of said plurality of zones having a repeater; and,
said communication between said reservation device and said base station being via said repeater which is located in said same zone as said communal item.

5. The reservation system according to claim 4, further including:
a plurality of communal items disposed in said communal item placement area; and,
said reservation system including a mesh wireless network wherein each of said repeaters communicates with (1) said base station, (2) other said repeaters, and (3) multiple reservation devices.

6. The reservation system according to claim 2, further including:
said reservation device having a communal item identifier; and,
said reservation device capable of sending said base station a communal item reserved signal which includes said communal item identifier.

7. The reservation system according to claim 6, further including:
said communal item placement area divided into a plurality of zones;
said communal item residing in one of said plurality of zones;
each of said plurality of zones having a repeater, each said repeater having a zone identifier;
said communication between said reservation device and said base station being via said repeater which is located in said same zone as said communal item;
said repeater receiving said communal item reserved signal from said reservation device and passing said communal item reserved signal to said base station;
said repeater measuring a signal strength of said communal item reserved signal received from said reservation device, and adding said signal strength to said communal item reserved signal before it is passed to said base station; and,
said repeater also adding said zone identifier of said repeater to said communal item reserved signal before it is passed to said base station.

8. The reservation system according to claim 2, further including:
said reservation device having a communal item identifier; and,
said reservation device capable of sending said base station a communal item available signal which includes said communal item identifier.

9. The reservation system according to claim 8, further including:
said communal item placement area divided into a plurality of zones;
said communal item residing in one of said plurality of zones;
each of said plurality of zones having a repeater, each said repeater having a zone identifier;
said communication between said reservation device and said base station being via said repeater which is located in said same zone as said communal item;
said repeater receiving said communal item available signal from said reservation device and passing said communal item available signal to said base station;
said repeater measuring a signal strength of said communal item available signal received from said reservation device, and adding said signal strength to said communal item available signal before it is passed to said base station; and,
said repeater also adding said zone identifier of said repeater to said communal item available signal before it is passed to said base station.

10. The reservation system according to claim 2, further including:
said reservation device having a communal item identifier; and,
said reservation device capable of sending said base station a service request signal which includes said communal item identifier.

11. The reservation system according to claim 10, further including;
said communal item placement area divided into a plurality of zones;
said communal item residing in one of said plurality of zones;
each of said plurality of zones having a repeater, each said repeater having a zone identifier;
said communication between said reservation device and said base station being via said repeater which is located in said same zone as said communal item;
said repeater receiving said service request signal from said reservation device and passing said service request signal to said base station;
said repeater measuring a signal strength of said service request signal received from said reservation device, and adding said signal strength to said service request signal before it is passed to said base station; and,
said repeater also adding said zone identifier of said repeater to said service request signal before it is passed to said base station.

12. The reservation system according to claim 2, further including:
said base station capable of sending said reservation device an information message.

13. The reservation system according to claim 2, further including:
said reservation device including a reserve activator; and,
when activated said reserve activator (1) causing said reservation device to enter said reserved state, (2) causing a communal item reserved signal to be sent from said reservation device to said base station, and (3) enabling said timer activator.

14. The reservation system according to claim 2, further including:
said reservation device including a service state;
said reservation device including a service activator; and,
when activated said service activator causing said reservation device to enter said service state and sending a service request signal from said reservation device to said base station.

15. The reservation system according to claim 2, further including:
said reservation device including a service activator;
when activated said service activator causing said reservation device to enter said service state and causing a service request signal to be sent from said reservation device to said base station; and
said reservation device including a system status display which when in said service state displays (1) a service message, and (2) a communal item identifier.

16. The reservation system according to claim 1, further including:
said timer activator including a motion sensor which senses movement of said communal item when said reservation device is connected thereto;
when in said reserved state, if no movement of said communal item is sensed within a time interval, said timer activator causing said timer to start; and,
once started if said timer runs for said period of time without said motion sensor sensing movement of said communal item, said reservation device changes from said reserved state to said available state.

17. The reservation system according to claim 1, further including:
said timer activator including a motion sensor which senses movement of said communal item when said reservation device is connected thereto;
when in said reserved state, if no movement of said communal item is sensed within a time interval, said timer activator causing said timer to start; and,
if movement is sensed before said period of time has elapsed, said timer stops and is reset.

18. The reservation system according to claim 1, further including:
said reservation device including a system status display which when said reservation device is in said reserved state displays a reserved message.

19. The reservation system according to claim 18, further including:
said system status display also capable of displaying a time generated by said timer.

20. The reservation system according to claim 1, further including:
said reservation device including a system status display which when said reservation device is in said available state displays an available message.

21. The reservation system according to claim 1, further including:
said reservation device including a timer reset function which when activated resets said timer.

22. Apparatus for reserving occupancy of a communal item which is disposed in a communal item placement area, the apparatus comprising:
a reservation device which is connectable to the communal item, said reservation device including;
an available state in which the communal item is available for use;
a reserved state in which the communal item is reserved;
a timer which runs for a period of time; and,
a timer activator which starts said timer.

23. The apparatus according to claim 22, the apparatus cooperating with a base station, the apparatus further including:
said reservation device capable of wirelessly communicating with the base station.

24. The apparatus according to claim 23, further including:
said reservation device having a communal item identifier; and,
said reservation device capable of sending the base station a communal item reserved signal which includes said communal item identifier.

25. The apparatus according to claim 23, further including:
said reservation device having a communal item identifier; and,
said reservation device capable of sending the base station a communal item available signal which includes said communal item identifier.

26. The apparatus according to claim 23, further including:
said reservation device having a communal item identifier; and,
said reservation device capable of sending the base station a service request signal which includes said communal item identifier.

27. The apparatus according to claim 23, further including:
said reservation device capable of receiving an information message from the base station.

28. The apparatus according to claim 23, further including:
said reservation device including a reserve activator; and,
when activated said reserve activator (1) causing said reservation device to enter said reserved state, (2) causing a communal item reserved signal to be sent from said reservation device to the base station, and (3) enabling said timer activator.

29. The apparatus according to claim 23, further including:
said reservation device including a service state;
said reservation device including a service activator; and,
when activated said service activator causing said reservation device to enter said service state and sending a service request signal from said reservation device to the base station.

30. The apparatus according to claim 23, further including:
said reservation device including a service activator;
when activated said service activator causing said reservation device to enter said service state and causing a service request signal to be sent from said reservation device to the base station; and
said reservation device including a system status display which when in said service state displays (1) a service message, and (2) a communal item identifier.

31. The apparatus according to claim 22, further including:
said timer activator including a motion sensor which senses movement of the communal item when said reservation device is connected thereto;
when in said reserved state, if no movement of the communal item is sensed within a time interval, said timer activator causing said timer to start; and,
once started if said timer runs for said period of time without said motion sensor sensing movement of the communal item, said reservation device changes from said reserved state to said available state.

32. The apparatus according to claim 22, further including:
said timer activator including a motion sensor which senses movement of the communal item when said reservation device is connected thereto;
when in said reserved state, if no movement of the communal item is sensed within a time interval, said timer activator causing said timer to start; and,
if movement is sensed before said period of time has elapsed, said timer stops and is reset.

33. The apparatus according to claim 22, further including:
said reservation device including a system status display which when said reservation device is in said reserved state displays a reserved message.

34. The reservation system according to claim 33, further including:
said system status display also capable of displaying a time generated by said timer.

35. The apparatus according to claim 22, further including:
said reservation device including a system status display which when said reservation device is in said available state displays an available message.

36. The apparatus according to claim 22, further including:
said reservation device including a timer reset function which when activated resets said timer.

37. A method for a user to reserve occupancy of a communal item, comprising:
(a) providing a communal item placement area;
(b) providing a communal item disposed in said communal item placement area;
(c) providing a reservation device which is connected to said communal item, said reservation device including;
an available state in which said communal item is available for use;
a reserved state in which said communal item is reserved;
a timer which runs for a period of time;
a timer activator which starts said timer;
a reserve activator which when activated (1) causes said reservation device to enter said reserved state, and (2) causes said timer activator to be enabled;
a system status display which when said communal item is available displays an available message, and when said communal item is reserved displays a reserved message;
(d) the user ensuring that said reservation device is in said available state by observing that said system status display displays said available message;
(e) the user activating said reserve activator thereby causing said reservation device to enter said reserved state, causing said timer activator to be enabled, and causing said reserved message to appear on said system status display; and,
(f) the user occupying said communal item.

38. The method of claim 37, further including:
providing a base station, said reservation device capable of wirelessly communicating with said base station;
in (e), activating said reserve activator also causing a communal item reserved signal to be sent from said reservation device to said base station.

39. The method of claim 37, further including:
in (c), said timer activator including a motion sensor which senses movement of said communal item;
the user vacating said communal item;
after vacating said communal item, if no movement of said communal item is sensed within a time interval, said timer activator causing said timer to start; and,
said timer running for said period of time without said motion sensor sensing movement of said communal item, thereby causing said reservation device to change from said reserved state to said available state.

40. The method of claim 37, further including:
in (c), said timer activator including a motion sensor which senses movement of said communal item;
the user vacating said communal item;
after vacating said communal item, if no movement of said communal item is sensed within a time interval, said timer activator causing said timer to start; and,
the user reoccupying said communal item before said period of time has elapsed, thereby causing said timer to stop and be reset.

41. The method of claim 37, further including:
in (c), said reservation device including a service state;
in (c), said reservation device including a service activator; and,
activating said service activator causing said reservation device to enter said service state.

42. The method of claim 37, further including:
in (c), said reservation device including a service state;
in (c), said reservation device including a service activator;
in (c), said reservation device including a system status display which when in said service state displays (1) a service message, and (2) a communal item identifier; and,
activating said service activator.

43. The method of claim 37, further including:
in (c), said reservation device including a timer reset function which when activated resets said timer; and,
facility personnel activating said timer reset function.

44. A timer for reserving occupancy of a communal item, comprising:
a timing mechanism which is settable to run for a period of time;
a timer control which is used to set said period of time;
a communal item available indicator which is positionable to (1) a retracted position during said period of time, and (2) to an extended position after said period of time has expired;
a control mechanism which, when said period of time has expired, causes said communal item available indicator to move to said extended position; and,
said timer connectable to the communal item.
